(19) United States
(12) Patent Application Publication
(10) Pub. No.: US 2015/0053493 A1
(43) Pub. Date: Feb. 26, 2015

(54) SUBFRAME ASSEMBLY AND ASSOCIATED METHOD OF INSTALLATION

(71) Applicant: FORD GLOBAL TECHNOLOGIES, LLC, Dearborn, MI (US)

(72) Inventors: Donatus Andreas Josephine KEES, Billericay Essex (GB); James Andrew STRAKER, Brentwood (GB)

(21) Appl. No.: 14/466,441

(22) Filed: Aug. 22, 2014

(30) Foreign Application Priority Data
Aug. 23, 2013 (GB) 1315131.1

(51) Int. Cl. B60K 1/04; B60K 11/00; B62D 25/24; B62D 21/11; B60K 13/04

(52) U.S. Cl. CPC B60K 1/04; B62D 21/11; B60K 13/04; B62D 25/24; B60K 11/00; B60K 2001/0438
USPC 180/68.5; 280/830

(57) ABSTRACT

A subframe assembly for a motor vehicle includes a suspension subframe defining a void and an ancillary device of the vehicle disposed at least partially within the void. The ancillary device may be a battery assembly or a urea tank. The battery assembly may include a heat exchange system, such as a fan configured to direct air flow to the battery assembly. At least a portion of the ancillary device may be integral to the suspension subframe.

### CROSS-REFERENCE TO RELATED APPLICATIONS

This application claims foreign priority benefits under 35 U.S.C. §119(a)-(d) to GB 1315131.1 filed Aug. 23, 2013, which is hereby incorporated by reference in its entirety.

### TECHNICAL FIELD

This invention relates to a subframe assembly for a vehicle and an associated method of assembly to the vehicle, and particularly, but not exclusively, relates to a subframe assembly comprising a suspension subframe and one or more ancillary devices of the vehicle.

### BACKGROUND

The use of subframes is common in the construction of vehicles. Subframes are discrete components of the overall structure of a vehicle and may be used to carry or mount certain vehicle components, such as engines, drivetrains or suspension components. Subframes are fixed to the vehicle, usually by way of welding or fasteners, and may be a structural component of the vehicle.

Vehicles also comprise many ancillary devices, such as electrical components and fuel system components. Careful consideration must be taken when determining the location of such ancillary devices within the vehicle to ensure that these ancillary devices are protected in the event of a crash. In passenger vehicles, conventional locations for the installation of ancillary devices are typically within the passenger compartment, the region forward of the rear axle and the region rearward of the front bulkhead.

However, it is undesirable to locate ancillary devices in regions that may be used for passenger accommodation. Installation of ancillary devices in such regions may impair the functionality of these regions. For example, locating the ancillary device in the trunk of the vehicle may result in the inability to stow bulky items, such as golf clubs or building materials.

Specific ancillary devices include batteries and associated electrical components, such as battery cooling systems, battery management systems and DC-DC converters. The packaging of such ancillary devices is becoming increasingly important as the demand for hybrid and electric vehicles increases.

Urea tanks are an ancillary device for diesel vehicles and are used to store aqueous urea solution (diesel exhaust treatment fluid), which is used as a consumable in the selective catalytic reduction of NOₓ in exhaust gases. Aqueous urea solution possesses a degree of toxicity and has an acrid odor. It is desirable, therefore, to locate the urea tank outside of the passenger compartment to mitigate the risk of exposing a passenger to the aqueous urea solution in the event that the urea tank develops a leak.

It is known to locate ancillary devices, such as batteries and urea tanks under the seats within the passenger compartment or within the engine bay. However, neither of these locations is desirable as they impinge on otherwise useful space within the passenger compartment and offer limited protection to the ancillary device during a crash.

The present invention seeks to address these issues.

### SUMMARY

According to a first aspect of the present invention there is provided a subframe assembly for a vehicle comprising: a suspension subframe; and at least one ancillary device of the vehicle, wherein the ancillary device is disposed at least partially within the suspension subframe.

The ancillary device may be a battery assembly or a urea tank assembly. The battery assembly may comprise one or more batteries and/or one or more ancillary battery components. The battery assembly may comprise one or more cooling members configured to exchange heat between the battery assembly and the environment. The battery assembly may comprise a first heat exchange system. The battery assembly may comprise one or more first fans configured to direct air flow to the battery assembly.

The urea tank assembly may comprise a urea tank and/or a urea tank feed pump. A urea tank filling port may be connected to the urea tank. The urea tank filling port may be disposed proximate to a fuel tank filling port of the vehicle.

The subframe assembly may be configured such that at least a portion of the ancillary device is integral to the suspension subframe. The ancillary device may provide structural support to the suspension subframe. The ancillary device may be disposed fully within the suspension subframe. The suspension subframe may be a front suspension subframe. The suspension subframe may be a rear suspension subframe.

The vehicle may comprise one or more subframe assemblies. The vehicle may comprise a floor panel comprising one or more openings configured to allow access to the subframe assembly. The vehicle may comprise one or more air deflectors configured to direct air flow towards the subframe assembly. The air deflectors may be configured to direct air from a passenger compartment of the vehicle.

The vehicle may comprise a system configured to heat or cool the ancillary device. The system may comprise a second heat exchange system. The second heat exchange system may be configured to: provide warm heat transfer fluid from a heat source of the vehicle for the purpose of heating the subframe assembly; and/or provide cold heat transfer fluid from a compressor of the vehicle for the purpose of cooling the subframe assembly. The heat source may be an engine, a gearbox and or an electric component of the vehicle. The system may comprise one or more second fans configured to direct air flow to the ancillary device.

According to another aspect of the present invention, there is provided a method of assembling a subframe assembly to a vehicle, wherein the subframe assembly comprises a suspension subframe and at least one ancillary device, the method comprising: installing the ancillary device to the suspension subframe such that the ancillary device is disposed at least partially within the suspension subframe; and installing the suspension subframe to the vehicle.

The ancillary device may be installed to the suspension subframe in a first operation and the suspension subframe may be installed to the vehicle in a second operation. The first operation may be completed before the second operation. The first operation may be completed after the second operation.

### BRIEF DESCRIPTION OF THE DRAWINGS

FIG. 1 shows a perspective view of the underside of a vehicle with an ancillary device located in a void in a rear suspension subframe.

FIG. 2 shows a partial cross sectional view of the vehicle with the ancillary device located in the void in the rear suspension subframe.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Subframe Assembly

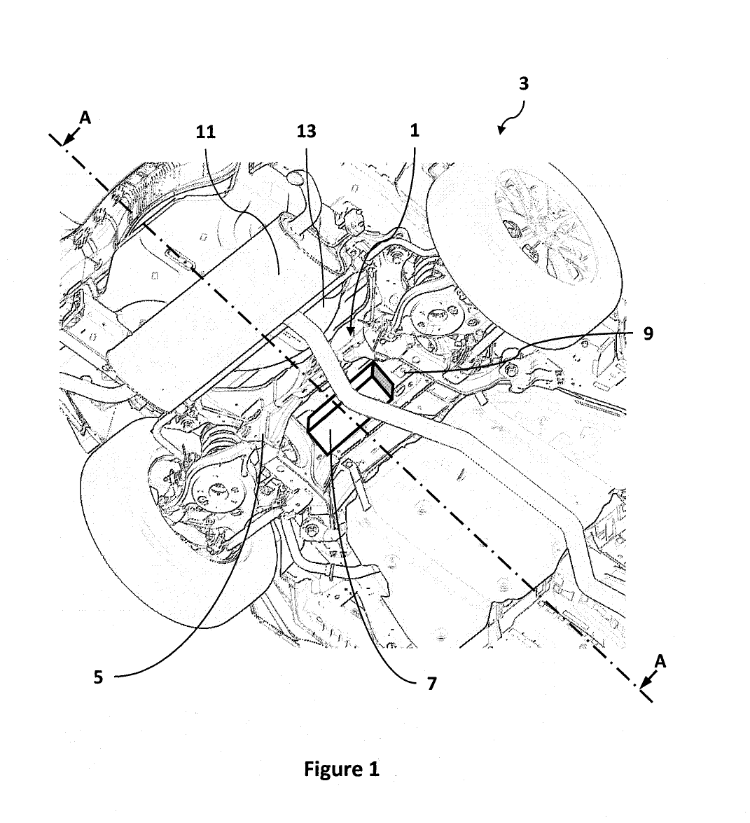

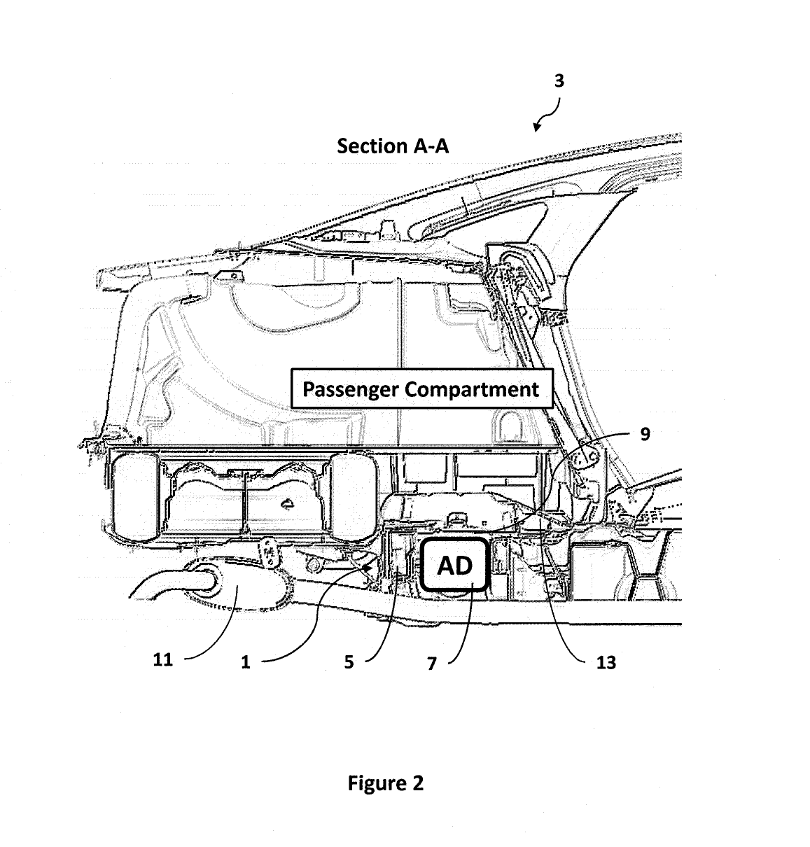

A subframe assembly 1 according to the present invention is shown in FIGS. 1 and 2, which depict the underside of a vehicle 3 and a cross section of the vehicle 3 respectively. The subframe assembly 1 comprises a suspension subframe 5 and at least one ancillary device 7 of the vehicle, wherein the ancillary device 7 is disposed at least partially within the suspension subframe. In the embodiment shown in FIGS. 1 and 2, the ancillary device 7 is disposed within a rear suspension subframe 5. In an alternative example, not shown, the ancillary device 7 may be disposed at least partially within a front suspension subframe.

The ancillary device 7 is disposed within a void 9 of the rear suspension subframe 5, which is an otherwise unoccupied space. It is desirable to locate the ancillary device 7 in the void 9 as the suspension subframe, such as the rear suspension subframe 5, may remain substantially free from damage during a crash. Furthermore, by locating the ancillary device 7 outside of the passenger compartment of the vehicle 3, the ancillary device 7 does not impinge upon usable interior space and, therefore, does not impair the functionality of the vehicle 3.

The ancillary device 7 may be a battery assembly, which comprises one or more batteries, e.g. a 12 Volt battery, a 48 Volt battery and/or a high voltage battery. The battery assembly may comprise one or more associated battery components, such as a battery management system, a battery disconnect system, a battery heat exchange system or a DC-DC converter.

As a means to regulate the temperature of the battery assembly, the battery assembly may comprise one or more cooling members configured to exchange heat between the battery assembly and the environment surrounding the subframe assembly 1. The cooling members may comprise one or more protrusions, e.g. fins, that dissipate heat passively into their surroundings. Additionally and or alternatively, the battery assembly may comprise a first heat exchange system, which actively regulates the temperature of the battery assembly. Furthermore, the battery assembly may comprise one or more first fans that are configured to direct air flow to the battery assembly. It is advantageous, therefore, to locate the battery assembly in the void 9 of the rear suspension subframe 5, as this location is exposed to external air flow that may be used to cool the battery assembly.

The ancillary device 7 may comprise a urea tank assembly, which may comprise one or more urea tanks and/or urea tank feed pumps. The urea tank assembly may be configured to supply an aqueous urea solution to the exhaust system 11 of the vehicle 3, thereby forming part of a selective catalytic reduction system of the vehicle 3. It is advantageous to locate the urea tank assembly outside of the passenger compartment as it mitigates the risk of contaminating the passenger compartment with aqueous urea solution. Furthermore, as the suspension subframe, such as the rear suspension subframe 5, may remain substantially free from damage during a crash, the urea tank assembly may be protected from damage during such an incident.

The vehicle 3 may comprise a urea tank filling port that is connected to the urea tank assembly of the subframe assembly 1. For the sake of convenience, the urea tank filling port may be located next to a fuel tank filling port of the vehicle 3. However, the urea tank filling port may be located at any other location of the vehicle 3 that allows access to the filling port for the purpose of refilling the urea tank. For example, the urea tank filling port may be located in the engine bay or the trunk of the vehicle.

In the embodiment shown in FIGS. 1 and 2, the ancillary device 7 is disposed fully within the rear suspension subframe 5. It may be appreciated, however, that the ancillary device 7 may be partially disposed within the rear suspension subframe 5. For example, a battery assembly and or a urea tank assembly may by partially contained within the void 9 of the rear suspension subframe 5, such that only a portion of the ancillary device 7 is located in the void 9. This may be of benefit if the packaging requirements of the ancillary device 7 are greater than the space available in the void 9 of the rear suspension subframe 5. The remaining portion of the ancillary device 7 may occupy some other otherwise unused space outside of the rear suspension subframe 5.

The ancillary device 7 may be at least partially integral to the rear suspension subframe 5, i.e. at least a portion of the ancillary device 7 may form a portion of the structure of the rear suspension subframe 5. For example, the urea tank may form one or more portions of the rear suspension subframe 5. In this manner, the ancillary device 7 may provide structural support to the rear suspension subframe 5.

The vehicle 3 may comprise one or more subframe assemblies 1, for example, the rear suspension subframe 5 may comprise the urea tank assembly and the front suspension subframe may comprise the battery assembly. The vehicle 3 may comprise a floor panel 13 that separates the passenger compartment from the environment external to the vehicle 3. The floor panel 13 may comprise one or more openings, e.g. hatches, that are configured to provide access to one or more of the subframe assemblies 1 for the purpose of maintenance and/or inspection of the subframe assemblies 1. For example, the openings may be used to change one of the batteries in the battery assembly or repair a leak on the urea tank feed pump. The opening may be provided with a cover that seals the passenger compartment from the environment external to the vehicle 3. In another example, the opening may permit air flow between the passenger compartment and the environment external to the vehicle 3. The opening may comprise an opening in a grommet of the vehicle 3, e.g. a high voltage cable grommet.

The vehicle 3 may comprise one or more air deflectors that are configured to direct air towards the subframe assembly 1. The air deflectors may be configured to direct air from the passenger compartment of the vehicle towards the subframe assembly 1. The air deflectors may be located on the underside of the floor panel 13 and may be near to the openings in the floor panel 13 of the vehicle 3. In this manner, as the vehicle 3 moves forward, air flow may be directed towards the subframe assembly 1 for the purpose cooling one or more of the ancillary devices 7. For example, air flow may be directed toward one or more of the cooling members of the battery assembly. Additionally and/or alternatively, the air deflectors may be configured to direct warm air from within the passenger compartment for the purpose of heating one or more of the ancillary devices 7. The air deflector may be incorporated into the cover over the opening. The air deflectors may be moveable and may be configured to direct air to one or more separate portions of one or more of the subframe assemblies 1.

Furthermore, the vehicle 3 may comprise one or more second fans that are configured to direct air flow towards the subframe assembly 1. The second fans may be located near to the subframe assembly 1 and may be configured direct air straight onto the ancillary device 7. Additionally and/or alternatively, the second fans may be located remotely from the subframe assembly 1 and may be configured to direct air flow towards one or more of the air deflectors. In another example, the fans may be incorporated into the cover of the opening for the purpose of providing a flow of air between the passenger compartment and the environment external to the vehicle 3.

The vehicle 3 may further comprise a system that is configured to heat or cool the ancillary device 7. The system may comprise a second heat exchange system that is configured to provide warm heat transfer fluid from a heat source of the vehicle 3, such as an engine, a gearbox and/or an electrical component of the vehicle 3, for the purpose of heating the ancillary device. The second heat exchange system may be configured to provide cold heat transfer fluid from a compressor of the vehicle 3 for the purpose of cooling the ancillary device. The second heat exchange system may comprise at least a portion of another heat exchange system of the vehicle 3, for example a coolant system of the engine or an air conditioning system.

Method of Installation

One method of assembling the subframe assembly 1 to the vehicle 3 comprises installing the ancillary device 7 to the rear suspension subframe 5, such that the ancillary device 7 is disposed at least partially within the rear suspension subframe 5. The method further comprises installing the rear suspension subframe 5 to the vehicle 3. The ancillary device 7 is installed to the rear suspension subframe 5 in a first operation and the rear suspension subframe 5 is installed to the vehicle in a second operation, wherein the first operation is competed before the second operation. In this way, the subframe assembly 1 may be installed to the vehicle 3 instead of a conventional suspension subframe.

It may be advantageous to manufacture and/or assemble the subframe assembly 1 at a different location to where the conventional rear suspension subframe 5 is assembled to the vehicle 3. Different versions of the subframe assembly 1 may be selected in accordance with the requirements of different variants of the vehicle 3. For example, a first subframe assembly may comprise the battery assembly comprising a plurality of batteries when installed to a first variant of the vehicle 3, e.g. a hybrid vehicle. Alternatively, a second subframe assembly may comprise the battery assembly and the urea tank assembly when installed to a second variant of the vehicle 3, e.g. a diesel vehicle. Furthermore, the subframe assembly 1 may be a common subframe assembly between any number of different types of vehicles.

In an alternative method of assembling the subframe assembly 1, the ancillary device 7 is installed to the rear suspension subframe 5 in the first operation and the rear suspension subframe 5 is installed to the vehicle in the second operation, wherein the first operation is competed after the second operation. In this manner, different types of ancillary devices 7 may be installed to the rear suspension subframe 5 after the suspension subframe 5 has been installed to the vehicle 3.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCE NUMERALS

1 subframe assembly

3 vehicle

5 rear suspension subframe

7 ancillary device

9 suspension subframe void

11 exhaust system

13 floor panel

What is claimed is:

1. A subframe assembly for a vehicle comprising:
a suspension subframe defining a void; and
at least one ancillary device of the vehicle disposed at least partially within the void.

2. The subframe assembly of claim 1, wherein the ancillary device comprises a battery assembly.

3. The subframe assembly of claim 2, wherein the battery assembly comprises at least one associated battery component.

4. The subframe assembly of claim 2, wherein the battery assembly comprises one or more cooling members configured to exchange heat between the battery assembly and an environment surrounding the subframe assembly.

5. The subframe assembly of claim 2, wherein the battery assembly comprises a heat exchange system.

6. The subframe assembly of claim 2, wherein the battery assembly comprises one or more fans configured to direct air flow to the battery assembly.

7. The subframe assembly of claim 1, wherein the ancillary device comprises a urea tank.

8. The subframe assembly of claim 1, wherein at least a portion of the ancillary device is integral to the suspension subframe.

9. The subframe assembly of claim 1, wherein the ancillary device is disposed fully within the void.

10. A vehicle comprising:
a suspension subframe defining a void; and
at least one ancillary device disposed at least partially within the void.

11. The vehicle of claim 10, further comprising a passenger compartment floor panel above the suspension subframe, the floor panel having at least one opening configured to allow access to the ancillary device.

12. The vehicle of claim 10, further comprising at least one air deflector configured to direct air flow towards the ancillary device.

13. The vehicle of claim 12, wherein the air deflector is configured to direct air from a passenger compartment of the vehicle.

14. The vehicle according of claim 12, further comprising a heat exchange system configured to transfer heat to and/or from the ancillary device.

15. The vehicle according to claim 14, wherein the heat exchange system is configured to provide a heat transfer fluid from a heat source of the vehicle to heat the ancillary device.

16. The vehicle according to claim 15, wherein the heat source is at least one of an engine, a gearbox and an electric component of the vehicle.

17. The vehicle according to claim 14, wherein the heat exchange system is configured to provide a heat transfer fluid from a compressor of the vehicle to remove heat from the ancillary device.
